(19) United States
(12) Patent Application Publication
(10) Pub. No.: US 2023/0160531 A1
(43) Pub. Date: May 25, 2023

(54) HYDROGEN STATION TESTING DEVICE

(71) Applicant: L'Air Liquide, Societe Anonyme pour l'Etude et l’Exploitation des Procedes Georges Claude, Paris (FR)

(72) Inventors: Samuel TROMPEZINSKI, Sassenage (FR); Francis EYNARD, Sassenage (FR)

(73) Assignee: L'Air Liquide, Societe Anonyme pour l'Etude et l?Exploitation des Procedes Georges Claude, Paris (FR)

(21) Appl. No.: 17/534,587

(22) Filed: Nov. 24, 2021

(51) Int. Cl. F17C 7/00; G01M 99/00

(52) U.S. Cl. CPC F17C 7/00; G01M 99/008; F17C 2265/065; F17C 2201/0104; F17C 2205/0142; F17C 2250/032; F17C 2221/012; F17C 2250/0443; F17C 2270/0184; F17C 2270/0168; F17C 2227/0157

(57) ABSTRACT

The disclosure generally describes an apparatus for simulating a refueling operation for a fuel cell electric vehicle (FCEV). The fuel is compressed hydrogen gas dispensed by hydrogen refueling station (HRS).

### CROSS-REFERENCE TO RELATED APPLICATIONS

### Field of the Invention

The disclosure relates to testing and certification of Hydrogen dispensing systems for fuel cell electric vehicles (FCEVs).

### Background Art

Currently, dispensers for refilling FCEVs are tested and validated with a test vehicle. While this is generally adequate to clear/not clear a dispenser, test vehicles are limited in the amount of data that can be collected and analyzed to identify specific issues. Further, a test vehicle can only be used with on dispenser, and one nozzle thereof, at a time.

Some technology providers have deployed alternative devices to substitute for a test FCEV. These include the Hydrogen Dispenser Testing Apparatus (HDTA) by CSA Group Testing & Certification Inc. This is a proprietary device and therefore limited information regarding it is available. The HDTA is used in conjunction with open source software. Sprik, Sam, and Terlip, Danny. HDTADA. Computer Software. https://github.com/NREL/HDTADA. USDOE Office of Energy Efficiency and Renewable Energy (EERE), Building Technologies Office (EE-5B). 18 Oct. 2018. Web. doi:10.11578/dc.20190204.1. The US Department of Energy funded a public project for another device, the Hydrogen Station Equipment Performance (HyStEP) Device. This publically available technology is accessible via <https://h2tools.org/hystep-hydrogen-station-equipment-performance-device>.

### SUMMARY OF INVENTION

The invention may be understood in relation to the following embodiments:

An apparatus for simulating a FCEV refilling process, the apparatus comprising
a) at least two inlets operable to form a gas tight connection with a hydrogen refueling station dispensing nozzle,
b) a set of at least two banks of gas cylinders in fluid communication with one of the at least two inlets, wherein the at least two banks of gas cylinders are configured to receive a gaseous hydrogen under pressure from the inlet with which said bank is in fluid communication,
c) an outlet for each cylinder of each bank of cylinders, the outlets of all cylinders from all banks of cylinders being in fluid communication with a common vent stack,
d) the vent stack configured and adapted to vent the pressurized hydrogen gas from the banks of cylinders, and
e) a computer specifically programed to operate the apparatus to perform a hydrogen gas transfer from the hydrogen refueling station dispensing nozzle to each of the separate banks of gas cylinders.

A method of simulating a fuel cell electric vehicle refilling with pressurized hydrogen gas, the method comprising,
a) Connecting at least two dispensing nozzles of a hydrogen refueling station to at least two separate inlets of the apparatus,
b) Activating a hydrogen refueling station's hydrogen gas dispenser, that is fluidically connected with the dispensing nozzles, to feed a pressurized hydrogen gas into the at least two inlets of the apparatus,
c) Receiving the pressurized gaseous hydrogen pursuant to a pre-defined, fuel cell electric vehicle (FCEV) refilling process to thereby simulate the refilling of a hydrogen storage of a FCEV pursuant to the pre-defined, fuel cell electric vehicle (FCEV) refilling process,
d) Collecting one or more items of information representing a flow of hydrogen gas through the at least two dispensing nozzles into the apparatus, and
e) Comparing the one or more items of information collected in step d) with pre-defined items of information representing the pre-defined, fuel cell electric vehicle (FCEV) refilling process.

### DISCLOSURE OF INVENTION

### Brief Description of Drawings

FIG. 1 shows an embodiment of the apparatus connected to the optional recycle system.

### Detailed Description

The disclosure generally describes an apparatus for simulating a refueling operation for a fuel cell electric vehicle (FCEV). The fuel is compressed hydrogen gas dispensed by hydrogen refueling station (HRS). Generally, the HRS is designed, built and operated to comply with various codes and standardized procedures. Exemplary codes and procedures are those published by SAE International:
SAE J2601 Fueling Protocols for Light Duty Gaseous Hydrogen Surface Vehicles.
SAE J2799 Hydrogen Surface Vehicle to Station Communications Hardware and Software
SAE J2600 Compressed Hydrogen Surface Vehicle Fueling Connection Devices

These standards are broadly recognized by US regulatory authorities as applicable standards for permitting HRS. But the apparatus described herein is adaptable to virtually any alternative codes or procedures.

The apparatus described herein advantageously allows an operator to a) collect more detailed information during a test refueling; b) test in parallel two or more dispenser nozzles connected to a common dispenser to facilitate identification and location of any issues within the dispenser system, e.g. a problem with a common valve versus a problem with one nozzle; and c) test dispenser nozzles on two or more different dispensers in parallel to further identify issues specific to a dispenser or stemming from a common upstream element associated with both dispensers.

Compared to a test vehicle, the apparatus herein also advantageously:
Can have larger hydrogen receptacle tanks to thereby allow for multiple refilling simulations before the accumulated hydrogen has to be emptied, thereby speeding up the process of testing a HRS;
Can be purposefully configured to safely and efficiently vent accumulated hydrogen; and
Can be configured to recycle some or all of the accumulated hydrogen back into the HRS, thereby avoiding loss of hydrogen inventory from a specific HRS as a consequence of testing and validation.

Embodiments will now be described for an apparatus adapted for a use with a HRS following J2601, J2799 and J2600.

The apparatus is equipped with two independent H70 receptacles. Each receptacle is connected to two independent banks of three 48L ASME Type II cylinders. For an apparatus with two H70 receptacles, a total of four (4) banks of 144L is available. H70 is approximately 70 MPa/10,000PSI. Alternative embodiments may have three or more receptacles, one or more of which may be instead H35 receptacles (35 MPa/5,000 PSI).

Each bank is equipped with one or more pressure sensors and, preferably, at least three temperature sensors, configured and adapted to measure State Of Charge (SoC) of the bank and manage hydrogen temperature for safety. The apparatus is configured with J2799 compliant infrared communication device(s) to enable the apparatus to simulate a FCEV refill with such a communication link. The apparatus is controlled by a specifically programmed computer with software adapted to operate the apparatus and collect and analyze the resulting data for evaluation of compliance with the applicable standard (e.g. J2601). In some embodiments, the software is adapted from the publically available HDTADA software.

Each bank can be vented separately and in a controlled manner (via a pressure ramp rate control for example). The apparatus is configured for and adapted to enable filling two banks while the two other banks are venting. Thanks to the four individual banks, the system is capable to simulate continuous 4-7 Kg category back-to-back fills (the detailed system fill capacity are given in the table below) on two dispenser nozzles. The back-to-back fills can be performed manually or in an automated mode.

All banks are preferably connected to a single vent stack. The vent stack can be connected either to the atmosphere, to a remote vent station (dispenser or station vent stack) or to a HRS recycling system.

The recycling system may consist of three independent Type I cylinders of a minimum of 1 m³ and enables recovery of up to 100% of the vented hydrogen for recycle back to the HRS, such as at a hydrogen pump intake of the HRS.

Embodiments having four or more banks are capable of continuous refueling simulations by having some banks receiving hydrogen while other banks vent or send hydrogen to recycle.

Embodiments connected to a recycle system are operable continuously and for an unlimited number of refill simulations due to the closed loop recycling of the gaseous hydrogen back to the HRS being tested.

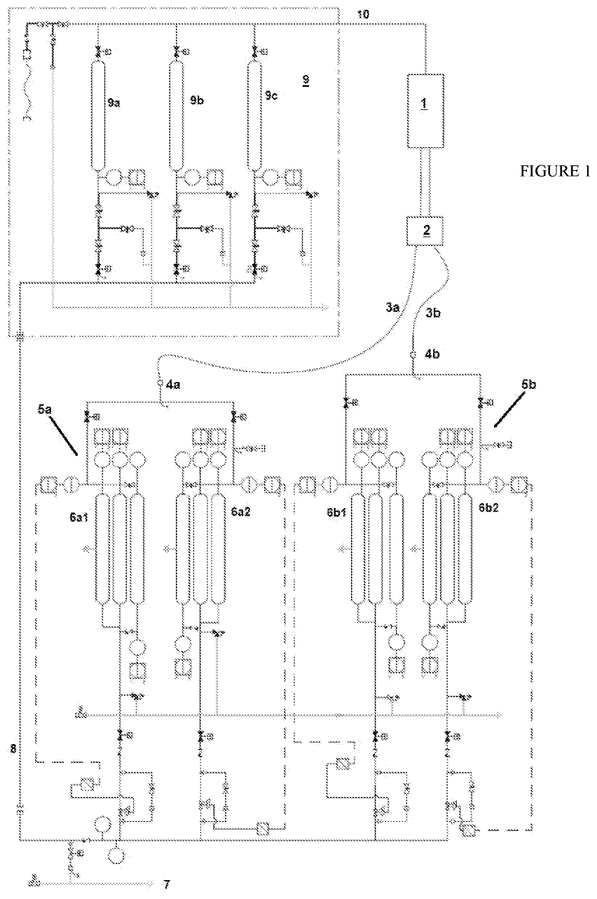

FIG. 1 shows an embodiment of the apparatus connected to the optional recycle system. The HRS (1) has at least one dispenser (2) which in turn has two hydrogen gas dispensing lines (3a, 3b), each with nozzles (4a,4b). The Apparatus has two separately operable banks (5a, 5b) of cylinders configured and adapted to independently execute a simulated refill of a FCEV using the SAE protocols identified above (or optionally other protocols). Each bank has a complement of individual gas cylinders (6a1, 6a2, 6b1, 6b2), generally three cylinders. Preferably the cylinders are Type II cylinders (aluminum, hoop-wrapped with carbon fiber). The apparatus has a common vent stack (7) for evacuating hydrogen from the banks. An alternative configuration is shown with conduit (8) directing the hydrogen gas to recycle system 9 instead. Recycle system (9) has a plurality of cylinders, generally three and preferably Type I cylinders (9a, 9b, 9c). Recycle system (9) feeds the hydrogen back into the HRS (1) for further use.

### INDUSTRIAL APPLICABILITY

The present invention is at least industrially applicable to testing and validating the correct functioning of hydrogen dispensing systems for refueling FCEVs.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. An apparatus for simulating a FCEV refilling process, the apparatus comprising
a) at least two inlets operable to form a gas tight connection with a hydrogen refueling station dispensing nozzle,
b) a set of at least two banks of gas cylinders in fluid communication with one of the at least two inlets, wherein the at least two banks of gas cylinders are configured to receive a gaseous hydrogen under pressure from the inlet with which said bank is in fluid communication,
c) an outlet for each cylinder of each bank of cylinders, the outlets of all cylinders from all banks of cylinders being in fluid communication with a common vent stack,
d) the vent stack configured and adapted to vent the pressurized hydrogen gas from the banks of cylinders, and
e) a computer specifically programed to operate the apparatus to perform a hydrogen gas transfer from the hydrogen refueling station dispensing nozzle to each of the separate banks of gas cylinders.

2. The apparatus of claim 1, further comprising a recycle line in fluid communication with the outlet for each cylinder of each bank of cylinders and configured to deliver a recycle stream of pressurized hydrogen to a recycle system, the recycle system configured and adapted to receive the recycle stream and further configured and adapted to return the recycle stream to the hydrogen refueling station.

3. The apparatus of claim 1, wherein the specifically programmed computer is programed to execute a gas transfer meeting a SAE J2601 standard.

4. The apparatus of claim 1, further comprising an infrared communication device, operably connected to the computer, the infrared communication device configured and adapted to execute a communication link with the hydrogen refueling station meeting a SAE J2799 standard.

5. The apparatus of claim 1, wherein the cylinders of the banks of cylinders are Type II cylinders.

6. The apparatus of claim 2, wherein the recycle system comprises a storage gas cylinder that is a Type I cylinder.

7. The apparatus of claim 6, wherein the recycle system comprises at least three Type I cylinders.

8. The apparatus of claim 1, wherein each bank of cylinders comprises at least three Type II cylinders.

9. A method of simulating a fuel cell electric vehicle refilling with pressurized hydrogen gas, the method comprising,
a) Connecting at least two dispensing nozzles of a hydrogen refueling station to at least two separate inlets of the apparatus of claim 1,
b) Activating a hydrogen refueling station's hydrogen gas dispenser, that is fluidically connected with the dispensing nozzles, to feed a pressurized hydrogen gas into the at least two inlets of the apparatus of claim 1,
c) Receiving the pressurized gaseous hydrogen pursuant to a pre-defined, fuel cell electric vehicle (FCEV) refilling process to thereby simulate the refilling of a hydrogen storage of a FCEV pursuant to the pre-defined, fuel cell electric vehicle (FCEV) refilling process,
d) Collecting one or more items of information representing a flow of hydrogen gas through the at least two dispensing nozzles into the apparatus of claim 1, and
e) Comparing the one or more items of information collected in step d) with pre-defined items of information representing the pre-defined, fuel cell electric vehicle (FCEV) refilling process.

10. The method of claim 9, wherein the comparison is performed by the specifically programmed computer of the apparatus of claim 1.

11. The method of claim 10, wherein the specifically programmed computer of the apparatus of claim 1, generates a report of the comparison, wherein deviations between the items of information collected in step d) and the pre-defined, fuel cell electric vehicle (FCEV) refilling process are separately identified.

12. The method of claim 9, wherein the apparatus of claim 1 comprises the infrared communication device of claim 4, and at least one item of information collected in step d) is collected via the infrared communication device of claim 4.

13. The method of claim 9, further comprising venting the pressurized hydrogen from the apparatus of claim 1.

14. The method of claim 9, further comprising recycling the pressurized hydrogen gas from the apparatus of claim 1 to the hydrogen refueling station.

15. The method of claim 14, wherein the recycled pressurized hydrogen gas is delivered to an inlet of a gaseous hydrogen compressor of the hydrogen refueling station.

16. The method of claim 9, wherein the pre-defined, fuel cell electric vehicle (FCEV) refilling process complies with a SAE J2601 standard.

17. The method of claim 12, wherein the pre-defined, fuel cell electric vehicle (FCEV) refilling process complies with a SAE J2799 standard.
